(19) United States
(12) Patent Application Publication
(10) Pub. No.: US 2007/0055534 A1
(43) Pub. Date: Mar. 8, 2007

(54) Method and system for implementing advertising and marketing campaign in electronic and computer devices

(76) Inventor: Wai Yin Lau, Hong Kong (HK)

Correspondence Address: Mr. Lau Wai Yin;Room 3103, 31 Floor, Kwong Sun House, Kwong Ming Court, Tseung Kwan O, New Territories, HK

(21) Appl. No.: 11/209,296

(22) Filed: Aug. 24, 2005

(51) Int. Cl. G06Q 99/00

(52) U.S. Cl. 705/1

(57) ABSTRACT

The invention is a advertising and marketing system relates to method and system to implement advertising and marketing campaign by delivering advertising and marketing message in electronic and computer devices. It integrates with the applications of the electronic and computer devices and applies algorithms to assign routing paths for message delivery. It comprises of three sub-systems and one side-system. The condition sub-system assesses the defined conditions and uses user choice algorithm, one-to-one simple algorithm, one-to-multiple complex algorithm and semi-complex algorithm as logistic to assign routing path. Alert side-system is running in condition sub-system level to persuade user to look for defined conditions. Following is the response sub-system to display the message with special effect to improve attractiveness of the message. Reinforcement sub-system is for enhancing the power of influence of message to the user.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

Not applicable.

### BACKGROUND OF INVENTION

The invention relates to method and system to implement advertising and marketing campaigns (the campaign) by delivering advertising and marketing message in electronic and computer devices (the device). It applies algorithms to assign routing paths for message delivery.

Advertisement is a process to promote products and services to consumers or target segments. The purpose of the promotion is to persuade, convince and influence target segments to receive, interpret without distortion and believe in the messages and reflect in their habitual or behavioral changes. For example, sponsor advertises to promote its mineral water and expect consumer chooses its mineral water instead of the others. Sponsor is trying to employ different kinds of media so as to reach consumers or target groups extensively. Television, radio, newspaper, magazine, banner etc are those we commonly know.

The sponsors and advertising agents are always looking for effective media to deliver advertising messages to target consumer groups to achieve higher successful rate in advertising and marketing campaign. Consumers may avoid receiving the advertising and marketing messages. They would go to washroom in commercial time, skip the commercial break in video tape, and flip to other pages in reading newspaper etc. Therefore the effectiveness of the advertisement is low and the degree of cost wastage is high.

The population of electronic and computer devices are very high. Those have a bright prospect to be new channels for the advertising and marketing campaigns. For example, electronic games such as video game, online game and mobile game are the most common application used in electronic and computer devices for pleasure. The penetration rate of electronic games is high in terms of depth and breadth in all market segments. It will be a cost-effective way for the corporations to promote their products. Therefore the devices are channels with high potential to be used for communicating with target segments in the near future.

### BRIEF SUMMARY OF INVENTION

In order to achieve a highly effective advertising and marketing campaign, advertising and marketing method and system (the system) is invented for delivering the message to users (the user) of the device. For example, it run the campaign in electronic game such as mobile game, online game, video game and any other game operating environment, and achieves the purpose of advertisement in a cost-effective way. The user triggers the advertising processes by achieving a defined condition. The defined condition is being assessed and routing path is assigned according to algorithm applied. Then the user will go through stages of message, special effect and reward or punishment. For example, the user finds the defined condition “soft drink” in the game. Message of “The Best Drink in the World” is shown. Finally, the user is rewarded by refilled “life power” in the game i.e. prolong the playing time.

The system comprises of three sub-systems and they are condition sub-system, response sub-system and reinforcement sub-system and are responsible for the functions of assessment, delivery and reinforcement. Alert side-system is also available to persuade the user to search for the defined conditions. Condition sub-system is to identify whether one of the defined conditions is achieved by the user and assign routing path for message. There are several algorithms used in the process of path assignment. User choice algorithm is applied to allow the user to select one of the items. The routing path would be assigned according to the user choice. For example, in online game, the user of the device is the game player. The user comes to a defined condition “found drinking water”, there will be a series of brand names displayed for the user to choose. If the user chooses sponsor mineral water, a positive conditional response path is assigned to reward the user in the games. If the user chooses the other mineral water, a negative conditional response path is assigned to punish the user in the game not to choose the one again.

There are also simple, complex and combo algorithms used for assigning routing path. The simplest one is the one-to-one algorithm in response to a defined condition. For example, in anti-smoking game, once user picks up the cigarette, scary skull picture is displayed with message of “Smoking kills you”. For a complex one-to-multiple algorithm, message will be delivered randomly or by a sequence. For example, in the anti-smoking campaign, messages will be chosen randomly in the list of “Smoking kills you”, “Smoking is hazardous to health” and “Your lungs are dead”.

Alert side-system is available to persuade to find a defined condition. It strengthens the defined condition to be stimulus in conditional response process. For example, in a mobile game, when “life power” drops to a low level, alert message “Thirsty” is given. Then the user will look for defined condition “found drinking water” to remove the “Thirsty”. The alert message “Thirsty” strengthens defined condition “found drinking water” to be a stimulus for initiating response “choose sponsor mineral water” and get reward.

The second sub-system is display sub-system. It displays the message and strengthens its effectiveness. The message may be in any format such as text, picture, movie clip or combination of those. The display method may be in form of banner, pop-up, runner or any other suitable method. In order to enhance the attractiveness of messages, display sub-system has a special effect following display to attract the user attentions. The special effects include sound, music clip, flashing or any other types to enhance the attractiveness of messages.

Reinforcement sub-system is the key sub-system for the objective of the system. It rewards the user when he does the thing right and punishes the user if he does something wrong. For example, on a war game, the user is being “hurt” and loss points in “life power”. The user takes up a “sponsor medication” and prolongs the playing time. In anti-smoking game, the user picks up cigarette and the game is over.

The system models the user to response to the message and finally changes the user behavior or habit. For example, the user experiences anti-smoking advertising campaign in video game and becomes a non-smoker. The system shall increase the effectiveness of the campaign in a relatively low cost. Although electronic game is used as examples above, the system is able to operate in all electronic and computer devices and integrate with their applications (such as game application, messaging application, e-mail application and any other application) for the campaign.

### BRIEF DESCRIPTION OF THE DRAWINGS

FIG. 1 is a general overview of the system to work in electronic game application to assess the defined condition, deliver and reinforce the advertising and marketing message.

FIG. 2 is a in-depth observation in the system with one-to-one simple algorithm.

FIG. 3 is showing the working of the user choice algorithm in the system with one-to-one algorithm

FIG. 4 is the work flow of the alert side-system

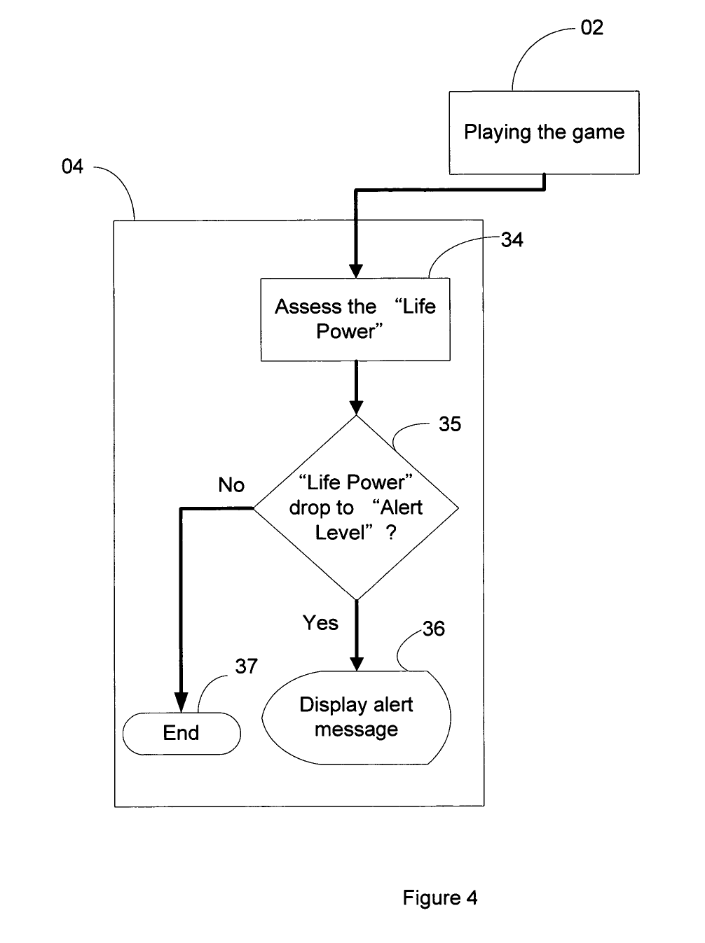

FIG. 5 is the routing table in simple one-to-one algorithm

FIG. 6 is the routing table in one-to-multiple complex algorithm in random form

FIG. 7 is the routing table in one-to-multiple complex algorithm in sequence form determined by defined condition found and times of defined condition being found

FIG. 8 is the routing table of semi-complex algorithm in random form in display and special effect stages but fixed path in reward or punishment stage.

FIG. 9 is the routing table of semi-complex algorithm in sequence form determined by defined condition found and times of defined condition being found in display and special effect stages but fixed path in reward or punishment stage

### DETAILED DESCRIPTION OF THE INVENTION

The system can be applied in all kinds of electronic and computer devices such as mobile, PDA, Smartphone, video game console, personal computer etc and their applications for advertising and marketing campaign. For the sake of explanation, game application is used in the following examples as a preferred embodiment. The preferred embodiment of the system will be described with drawings. It is applying three defined conditions with the simple one-to-one algorithm for assigning routing path. The details of the preferred embodiment and specific implementation are set forth in order to illustrate, not to limit, the invention. Variations the preferred embodiment will also be described.

1. Overview

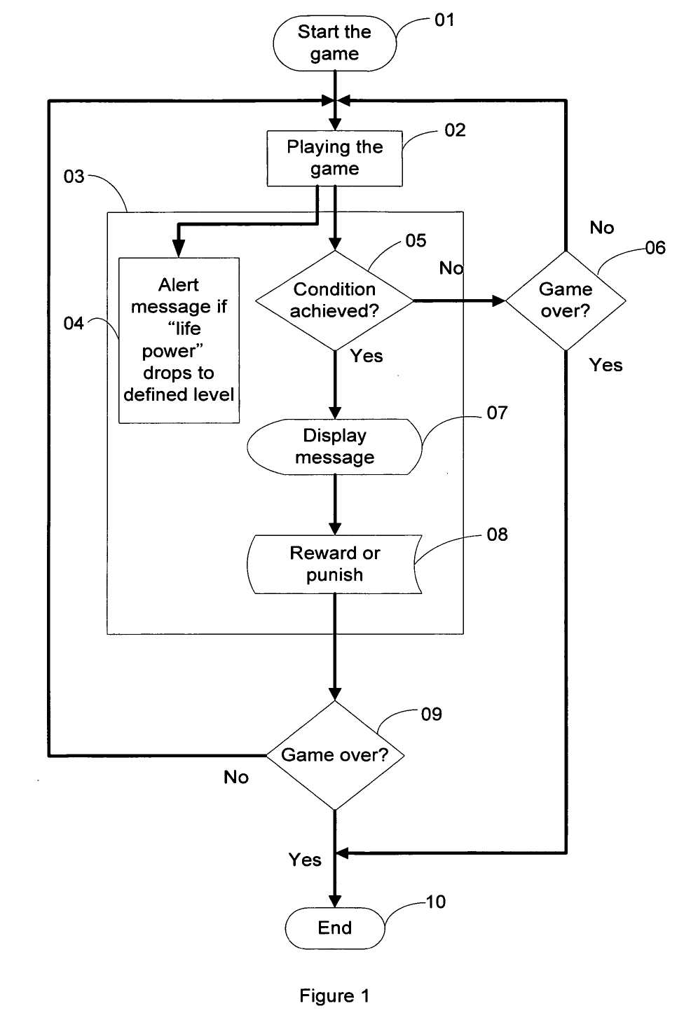

FIG. 1 shows the general overview of the system to work with the game and deliver the campaign. Once the user starts the game in 01, the system 03 is automatically running with the game to screen the actions taken by the user in 05. At the same time, an alert side-system 04 is running in parallel to alert the user on the “life power” i.e. the playing time left. When the user achieves one of the defined conditions, 05 will identify the defined condition and assign routing path. The user will go to 07 for the message with special effect. Finally 08 will reward or punish the user. The user will return to 02 to continue playing or end in 10.

2. Condition Sub-Systems

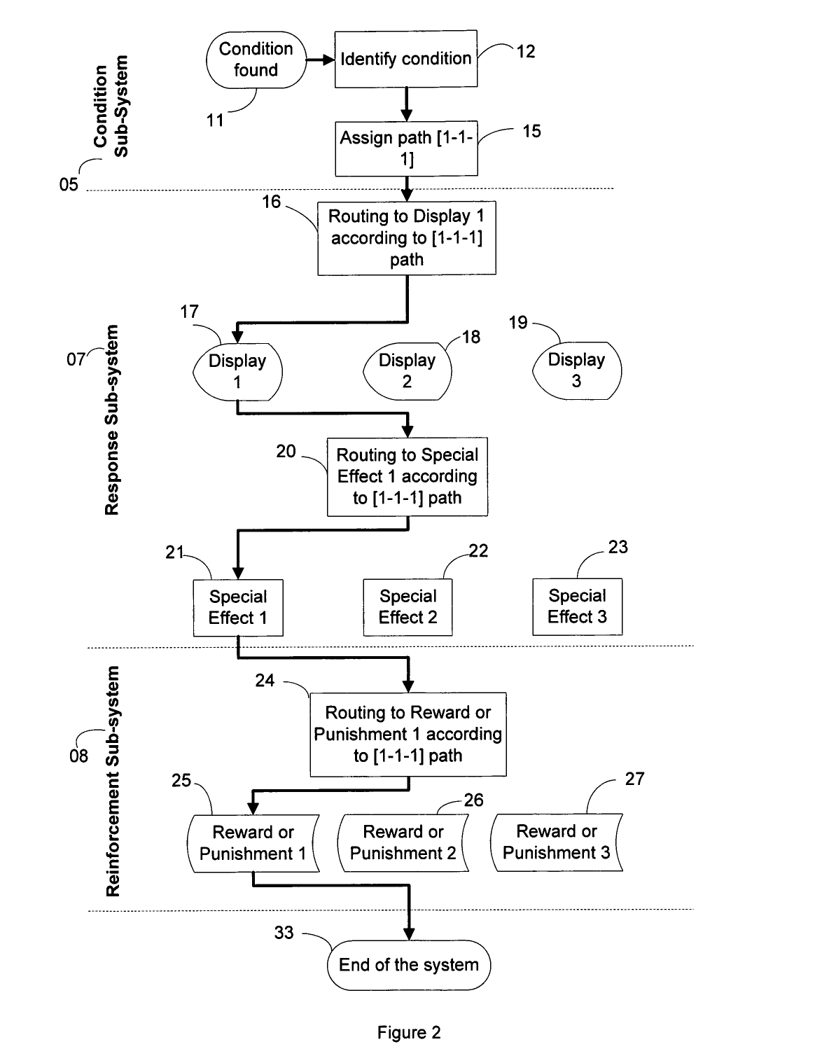

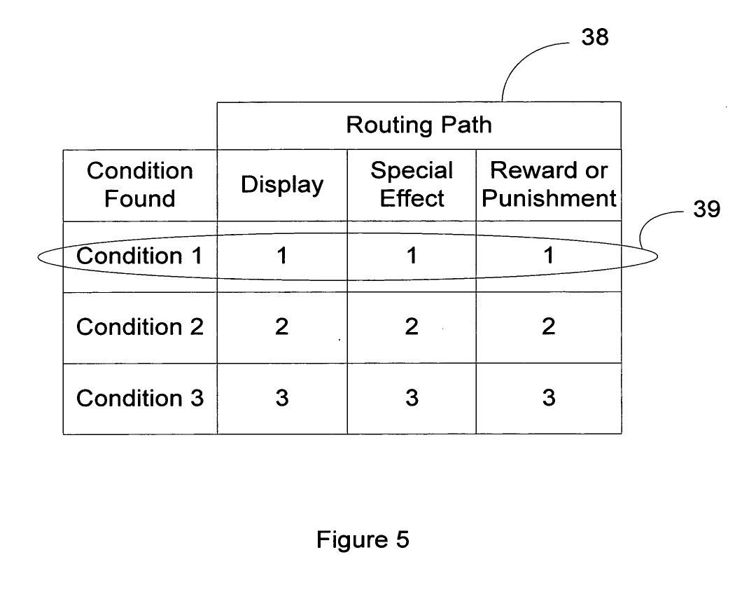

05 is condition sub-system to identify and assign routing path to a defined condition with reference to algorithm used. In FIG. 2, 11 assesses whether the user has found a defined condition. 12 identifies the defined condition and 15 assigns a routing path. For example, the user finds Condition 1. The routing path is assigned according to the routing table in 15. FIG. 2 shows an example of which 12 identifies Condition 1 and 15 assigns routing path 39 i.e. 1-1-1 with reference to the routing table 38 in FIG. 5. Therefore the advertising message is displayed in the sequence of 17 Display 1, 21 Special Effect 1, and 25 Reward or Punishment 1 in routing point 16, 20 and 24 respectively as shown in FIG. 2.

3. Complex One-to-Multiple Algorithm or Semi-Complex Algorithm

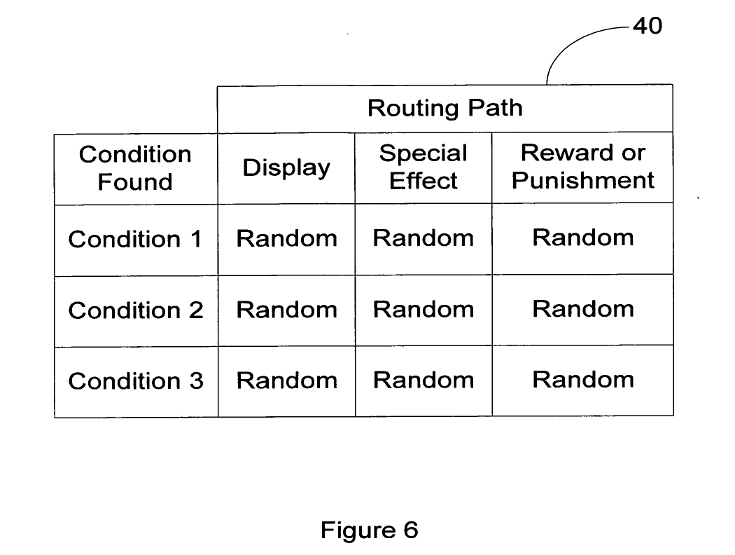

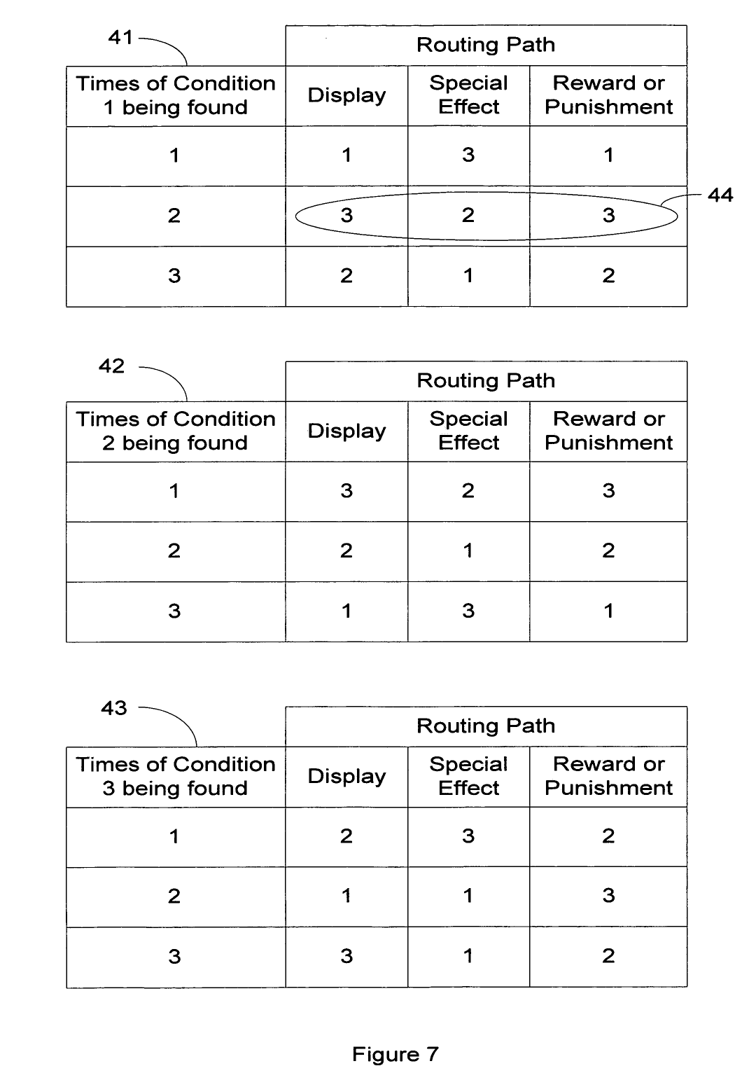

Complex one-to-multiple algorithm and semi-complex algorithm may be used to replace the simple one-to-one algorithm. FIG. 6 shows the routing table 40 to assign the path in random. FIG. 7 shows a pre-defined sequence to assign routing path according to the defined condition and times of defined condition found defined in routing table 41, 42 and 43. For example, 15 identifies Condition 1 and it is the second time for Condition 1 being identified. The routing table 41 is used for Condition 1 routing. Then the second row 44 of 41 is located that it is second time to find Condition 1. Therefore the routing path is 3-2-3 as show in 44. It means that 19 Display 3 shall be shown and 22 Special Effect 2 shall be used to increase the power of its attractiveness. Finally the 27 Reward or Punishment 3 shall be updated the “life power”.

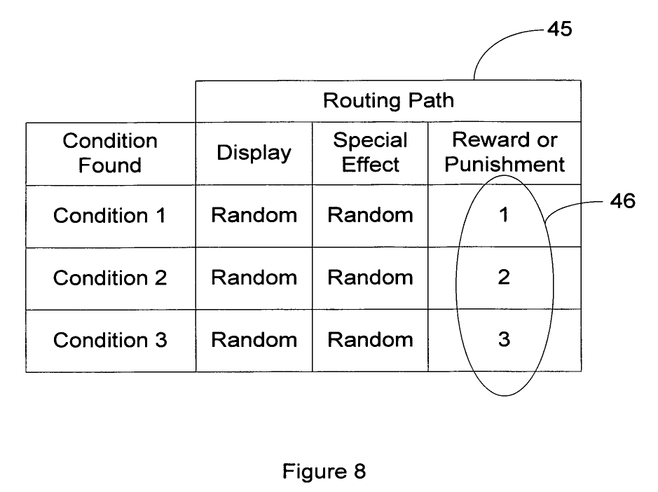

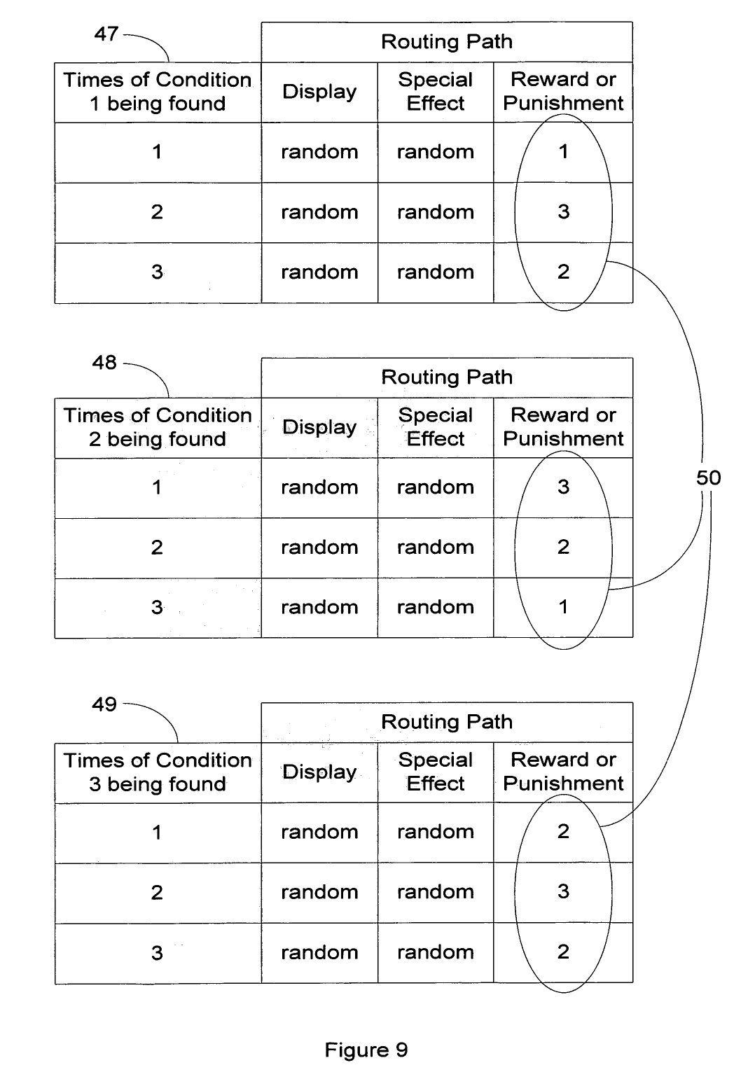

For semi-complex algorithm, one or two of the routing points is fixed. FIG. 8 shows that the routing table 45 has the reward or punishment 46 fixed while the display and special effect are randomly assigned. The semi-complex algorithm can also be applied in pre-set sequence routing table. In FIG. 9, the routing table 47, 48 and 49 have the reward or punishment 50 fixed.

4. User Choice Algorithm

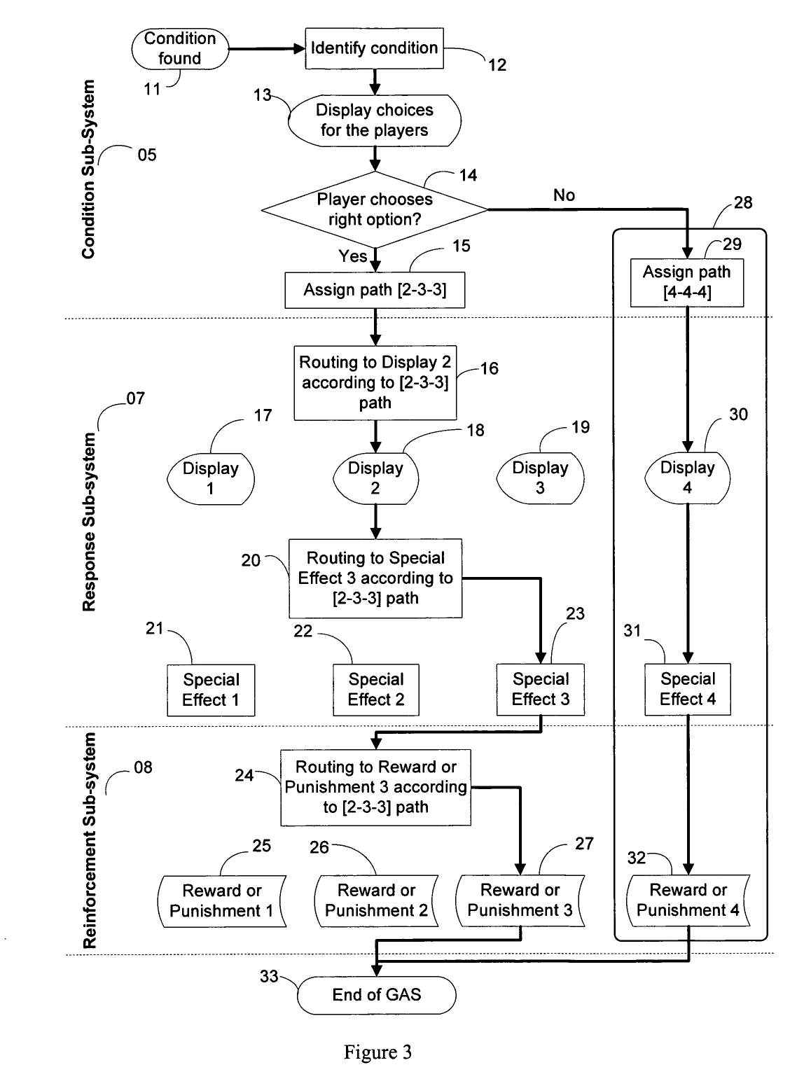

User choice algorithm is shown in FIG. 3. 12 identifies the defined condition. 13 displays choices to the user. If the user chooses the right one in 14, 15 will assign routing path for positive conditional response reinforcement ie. encourage the behavior. For example, path 2-3-3 is assigned i.e. 18 Display 2, 23 Special Effect 3 and 27 Reward or Punishment 3. Otherwise a separate path 28 for wrong decision is assigned for negative conditional response reinforcement i.e. discourage the behavior. For example, 12 identifies Condition 2 and the user chooses the right choice in 14. 15 assigns 2-3-3 routing path for message delivery. If the user chooses the wrong one, a 29 assign 4-4-4 routing path i.e. 30 Display 4, 31 Special Effect 4 and 32 Reward or Punishment 4.

5. Response Sub-System

07 is the response sub-system to display the message and improve its attractiveness by special effect. The message and special effect are matched with the assigned routing path in 15. For example, the path is assigned 1-1-1 in 15. 17 Display 1 and 21 Special Effect 1 are used to deliver the message.

21, 22, and 23 improve the attractiveness of the message displayed. There are many methods to increase the attractiveness such as flashing the message, playing a sound track, playing a music clip etc.

6. Reinforcement Sub-System

08 is reinforcement subsystem. It is the most important component to reinforce the relationship of stimulus and response. 24 routes the user to either 25, 26 or 27 for reward or punishment. For example, in 1-1-1 routing path, 24 acknowledges that 25 Reward or Punishment 1 is used to update the “life power” to reward or punish the user in the game. Afterwards, the user returns to the game mode 09.

7. Alert Side-System

Alert side-system 04 further improves the effectiveness of the system as some of the electronic games do not have mechanism to alert the user on level of “life power” explicitly. FIG. 5 shows the general workflow in the alert side-system. 34 and 35 are screening the “life power” and 36 will alert the user once the “life power” drops to certain level. For example, the pre-defined level is 25%. Once the “life power” drops to 25%, alert message “Thirsty” is displayed to urge the user seeking the defined condition “found drinking water” which is a defined condition for advertising message. This alert strengthens defined condition as a stimulus for a conditional response fixation process. Alert message will not be displayed if 34 and 35 find the “life power” is above the pre-defined level.

1. Advertising and marketing method and system to implement advertising and marketing campaign by delivering advertising and marketing message in electronic and computer devices.

2. Advertising and marketing method and system according to claim 1, comprising condition sub-system to identify the defined condition and assign routing path for message delivery and reinforcement.

3. Advertising and marketing method and system according to claim 1, comprising response sub-system to display advertising and marketing message and special effect according to assigned routing path and routing table.

4. Advertising and marketing method and system according to claim 1, comprising reinforcement sub-system to reinforce the message by reward or punish the user.

5. Advertising and marketing method and system according to claim 2, wherein user choice algorithm in condition sub-system to assign a path according to the choice made by the user to produce positive or negative conditional response training.

6. Advertising and marketing method and system according to claim 2, wherein simple one-to-one algorithm, complex one-to-multiple algorithm and semi-complex algorithm used for assigning routing path.

7. Advertising and marketing method and system according to claim 2, wherein alert side-system of condition sub-system to persuade the user to look for the defined conditions.
